(19) United States
(12) Patent Application Publication
(10) Pub. No.: US 2018/0301127 A1
(43) Pub. Date: Oct. 18, 2018

(54) DEVICE AND METHOD FOR INCREASING REVERB IN SNARE DRUM

(71) Applicant: Edward Walker, III, Deland, FL (US)

(72) Inventor: Edward Walker, III, Deland, FL (US)

(21) Appl. No.: 15/925,250

(22) Filed: Mar. 19, 2018

Related U.S. Application Data
(60) Provisional application No. 62/475,499, filed on Mar. 23, 2017.

(51) Int. Cl. G10D 13/02

(52) U.S. Cl. CPC G10D 13/025; G10D 13/023; G10D 13/021; G10D 13/028

(57) ABSTRACT

The present invention generally consists of a mechanical device which is placed inside an acoustic musical drum to produce “reverb”, a desired musical effect when the drum is struck on the drum head or rim. A combination of the reverberation springs' mechanical contact with the drum when struck and the resulting pulse of air generated by the strike causes the springs to vibrate, thus causing a reverb effect when the drum is struck in any manner or location.

This spec sheet can be crossed referenced to application 62/475,499 filed Mar. 23, 2017

### TECHNICAL FIELD

The present invention generally consists of a mechanical device which is placed inside an acoustic musical drum to produce “reverb” when the drum head or rim is struck, creating a desired musical effect.

### BACKGROUND

The word “snare” in this application refers to a particular type of drum commonly known as a “snare drum”. A snare drum or side drum is a percussion instrument that produces a sharp staccato sound when the head is struck with a drum stick. Snare drums are often used in orchestras, concert bands, marching bands, parades, drumlines, drum corps, and other musical applications. The snare drum is one of the central pieces in a drum set, a collection of percussion instruments designed to be played by a seated drummer. Snare drums can be played with drum sticks or other beaters such as brushes or rutes, which are used to achieve different sounds.

It is desirable in certain drum applications to increase the reverb of the drum to alter the drum's sound. The use of electrified springs to create a reverb effect has existed and is most commonly used in guitar amplifiers. In these methods, the use of a spring requires electronic circuitry, typically fed with an electric signal through a wire. Other methods of increasing reverb exist which us permanently installed features such as membranes with apertures that change air flow. These are complex to install and do not create resonance when the drum is struck on the rim. There is currently no means of created a reverb effect with simple mechanical means when drum is struck on the drum head and or the drum rim. It would be beneficial if there was a way to increase reverb during any means that a drum can be played and did not require an electric power source, complex external equipment, or cumbersome devices. In addition, it would be beneficial if there were a means of increasing the reverb effect of a drum with a mechanical method that can be easily installed and removed as desired.

### SUMMARY

The invention of this application is solely mechanical, with the reverb effect being created by springs, which are actuated by physical striking of the drum head or drum rim. The preferred spring referred to in this application is a specific type of spring known as an extension spring, also known as a tension spring, which are in the form of helical wound coils, wrapped tightly together to create tension. Extension springs can have hooks, loops, or end coils that are pulled out and formed from each end of the body. In the device of the current invention, a combination of the springs' mechanical contact with the drum when struck and the resulting pulse of air generated by the strike causes the springs to vibrate, thus causing a reverb effect when the drum is struck in any manner or location, such as on the drum head or the drum rim.

In accordance with an exemplary embodiment, the mechanical reverb device has a support structure consisting of a frame that has a cylindrical shape and mounts snugly to the interior of the drum shell. This embodiment is comprised of three main parts: the frame piece, the tension screws, and the reverb springs. The frame itself can either be constructed from machined aluminum or wood, or molded from a thermoset or thermoplastic. Sizes may vary but in one exemplary embodiment, the device will measure approximately 14 inches in diameter.

In another embodiment, the assembled frame will consist of 4 identical arch frame pieces forming a circle held together by tension screws. The springs are stretched across the frame and held in place by spring mounting holes drilled into the frame. The springs can vary in length, spring wire diameter and tension, depending upon the desired reverb sound produced. The descriptions herein are not intended to limit in any way the type of spring, amount of springs, or tension of spring that would adhere to the present invention.

In another exemplary embodiment, the frame is in the form of an I beam with curved ends. The I-beam has threaded apertures for set screws to be installed. The set screws can be tightened against the inner wall of the drum barrel in order to hold the frame in place. Mechanical reverb components such as springs are stretched across the I-beam to create a reverb sound in the drum. Said set screws can be provided with a bearing surface to contact the inner wall of drum barrel. The bearing surface of the set screws can be in the form of a plastic plug, rubber stopper, or any other advantageous material or shape that could be used for the purpose of setting the frame in the drum housing.

In another embodiment, the I beam's central main beam is split with threaded ends on each cut surface extending in alignment with the length of the beam, with each threaded end attached with a threaded length adjustment screw knob which can be rotated to extend or shorten the length of the central beam. This tightens the frame against the inner wall of the drum barrel in order to hold the frame in place.

In another exemplary embodiment, the frame is constructed with multiple layers, so that multiple springs can be hung in parallel along the height of the drum.

In another exemplary embodiment, the drum is constructed with internal brackets that allow reverberation springs to be stretched across the inside of the drum barrel. The reverb invention described herein can be installed by a drum manufacturer at the factory, or installed in a secondary operation by a craftsman, or installed with an installation kit by a do it yourself drum owner.

In another embodiment, in addition to the spring device, the drum contains an internal tone control muffler which is mounted inside the drum in a way that allows its position to be adjusted from the exterior of the drum. The muffler has an arm connect to a felt pad, which can be positioned to be in contact with or free from the reverberation device springs. When the muffler position is moved into contact with the reverberation device springs, it can exert pressure with felt pad against the springs of the reverberation device, in order to reduce or eliminate the reverberation function.

Although the device for application is demonstrated inside a snare drum, A variety of other drum types exist, and any version of the present invention can be used in keeping with the spirit of this patent. The current invention could be applied to any type of acoustical drum such a tom-toms or kick/bass drums.

The embodiments of the present invention specified herein are in no way meant to limit the claims to such detail.

### BRIEF DESCRIPTION OF THE DRAWINGS

The following detailed description of illustrative embodiments of the present application and appended drawings as well as the description given about are provided for the purposes of illustrating the present application. There is shown in the drawings illustrative embodiments of the disclosure. It should be understood, however, that the application is not limited to the precise arrangements and instrumentalities shown or described.

FIG. 1 is a top view of an embodiment 1, comprised of an annular hoop formed in 4 sections, with flange sections at the ends of each hoop section, and set screws to adjust the distance between each partial hoop end to tighten the hoop against the inner wall of a drum. with two reverberation springs installed.

FIG. 2 is a side view of embodiment 1.

FIG. 3 is a is a top view of an embodiment 2, comprised of an annular hoop formed in two half sections, attached at one end by a hinge which is positioned to allow the hoop to open and close, and in the second end by a set screw that can be adjusted to tighten the hoop against the inner wall of a drum by opening a space between the two half sections.

FIG. 4 is a top view of embodiment 2.

FIG. 5 is a is a top view of an embodiment 3, comprised of an annular hoop formed in one piece with one break in the continuity of the hoop, the two ends of the break in the hoop each having a flange, being connected by a set screw or other adjustable device, said break opening being adjustable with adjustable device so that the overall diameter of the hoop can be increased or decreased in order to tighten the hoop against the inner wall of a drum.

FIG. 6 is a perspective view of embodiment 3.

FIG. 7 is a top view of embodiment 3 installed in the annular body of a drum shell.

FIG. 8 is a perspective view of embodiment 3 installed in the annular body of a drum shell.

FIG. 9 is a side view of embodiment 3 installed in the annular body of a drum shell.

FIG. 10 is a cross section view FIG. 9.

FIG. 11 is a side view of embodiment 1, with an alternate more flexible material is attached to the outer diameter surface of the hoop to flexibly interact and provide bearing surface with the inner diameter of the drum barrel.

FIG. 12 is a perspective view of embodiment 4, where the removable attachment means is in the form of an I-beam, with the central main beam crossing the interior of the drum, with partial arch members at each end shaped to match the contours of the interior of the drum.

FIG. 13. Is a side view of embodiment 4.

FIG. 14 is a top view of embodiment 4 with 6 reverberation springs attached.

FIG. 15 is a perspective view of an I beam shaped attachment means with multiple layers of springs stacked in the vertical direction.

FIG. 16 is a perspective view of an I beam shaped attachment means wherein the removable attachment means is held in place with set screws, that when rotated put pressure on the inner wall of a drum.

### DETAILED DESCRIPTION

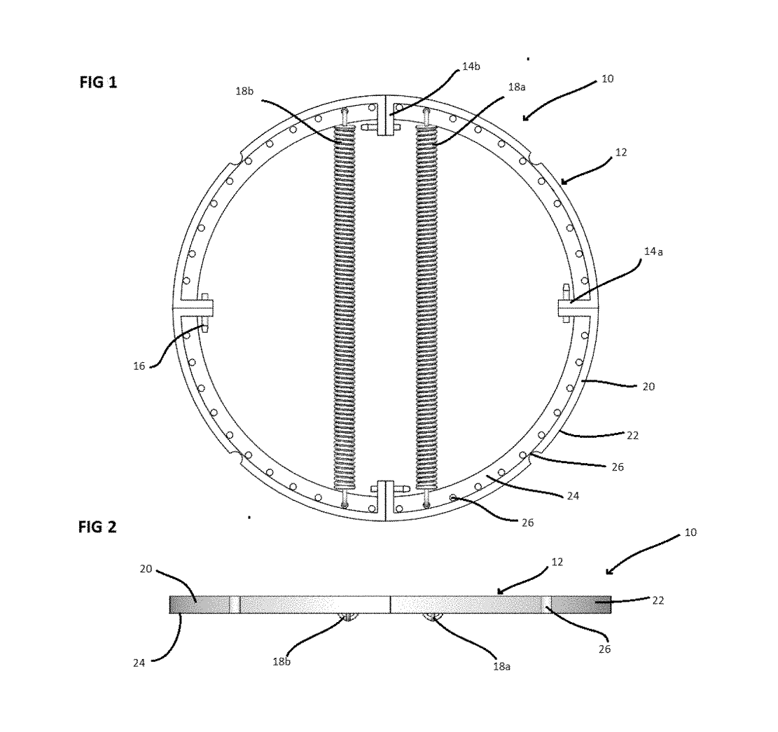

FIG. 1 illustrates one embodiment of a mechanical reverb device 10 including an annular hoop formed in four sections 12, with flange sections 14a and 14b at the ends of each hoop section, and small tension rods 16 to adjust the distance between each partial hoop end by rotation of each tension rod with a drum key to tighten the hoop against the inner wall of a drum. The hoop cross section is in the form of an L with the one exterior wall 20 having an exterior wall surface 22 designed to press against the inner diameter of the drum shell, and a reverberation spring mounting surface 24 extending radially inward toward the center of the drum having spring attachment apertures 26 for the mounting of reverberation springs 18. Two reverberation springs 18a and 18b are installed through the spring mounting apertures to alter the sound of the drum when the drum is struck on the drum head or rim. Each hoop section is provided with a bypass notch 28 in the exterior diameter of the hoop to allow bypass of internal screws of the inner drum barrel during installation.

FIG. 2 illustrates a side view of embodiment one mechanical reverb device 10 including an annular hoop formed in four sections 12. The hoop cross section is in the form of an L with the one exterior wall 20 having an exterior wall surface 22 designed to press against the inner diameter of the drum shell, and a reverberation spring mounting surface 24 extending radially inward toward the center of the drum having spring attachment apertures for the mounting of reverberation springs 18. Two reverberation springs 18a and 18b are installed through the spring mounting apertures to alter the sound of the drum when the drum is struck on the drum head or rim. Each hoop section is provided with a bypass notch 28 in the exterior diameter of the hoop to allow bypass of internal screws of the inner drum barrel during installation.

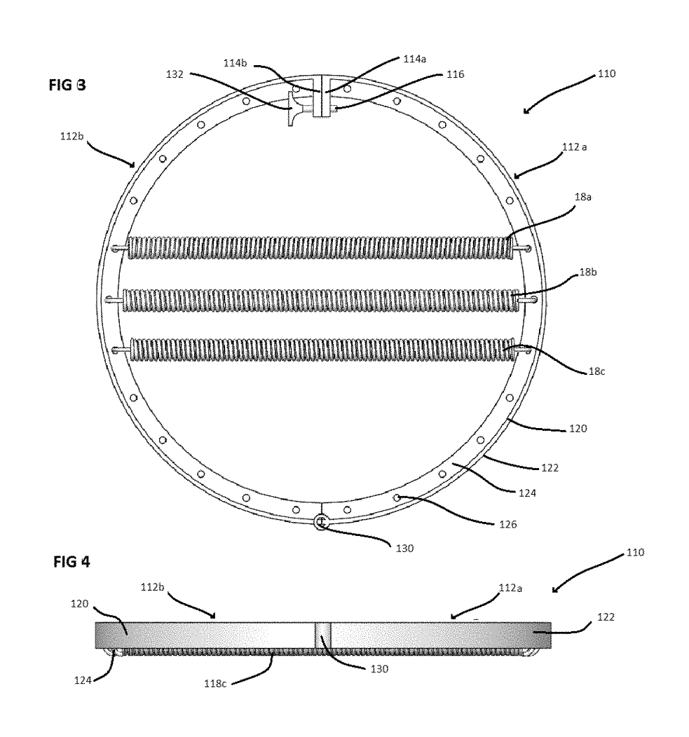

FIG. 3 illustrates a second embodiment of a mechanical reverb device 110 including an annular hoop formed in two sections 112a and 112b, attached at one end by a hinge 130 which is positioned to allow the hoop to open and close at the opposite end, and said opposite ends each having a flange 114a and 114b attached together by a set screw 116 that can be adjusted to tighten the hoop against the inner wall of a drum by rotating set screw knob 132, opening a space between the two half sections 112. The hoop cross section is in the form of an L with the one exterior wall 120 having an exterior wall surface 122 designed to press against the inner diameter of the drum shell, and a reverberation spring mounting surface 124 extending radially inward toward the center of the drum having spring attachment apertures 126 for the mounting of reverberation springs 118. Three reverberation springs 118a, 118b, and 118c are installed through the spring mounting apertures to alter the sound of the drum when the drum is struck on the drum head or rim.

FIG. 4 illustrates is a side view of the second embodiment of a mechanical reverb device 110 including an annular hoop formed in two sections 112a and 112b, attached at one end by a hinge 130 which is positioned to allow the hoop to open and close at the opposite end, and said opposite ends each having a flange by a set screw that can be adjusted to tighten the hoop against the inner wall of a drum by rotating set screw knob, opening a space between the two halves sections 112. The hoop cross section is in the form of an L with the one exterior wall 120 having an exterior wall surface 122 designed to press against the inner diameter of the drum shell, and a reverberation spring mounting surface 124 extending radially inward toward the center of the drum having spring attachment apertures for the mounting of reverberation springs 118. Three reverberation springs are installed through the spring mounting apertures to alter the sound of the drum when the drum is struck on the drum head or rim.

FIG. 5 illustrates a third embodiment of a mechanical reverb device 210 including an annular hoop formed in one section 212, with one break 234 in the continuity of the hoop to allow the hoop to open and close, two ends of the loop each having a flange 214a and 214b attached together by a set screw 216 that can be adjusted to tighten the hoop against the inner wall of a drum by rotating set screw knurled screw head 232, opening a space between the hoop 212. The hoop having one exterior wall surface 222 designed to press against the inner diameter of the drum shell, and an interior surface 236 upon which loops 238 are stamped or formed, each loop having spring attachment apertures 226 for the mounting of reverberation springs 218. Six reverberation springs 218a, 218b, 218c, 218d, 218e and 218f are installed through the spring mounting apertures to alter the sound of the drum when the drum is struck on the drum head or rim.

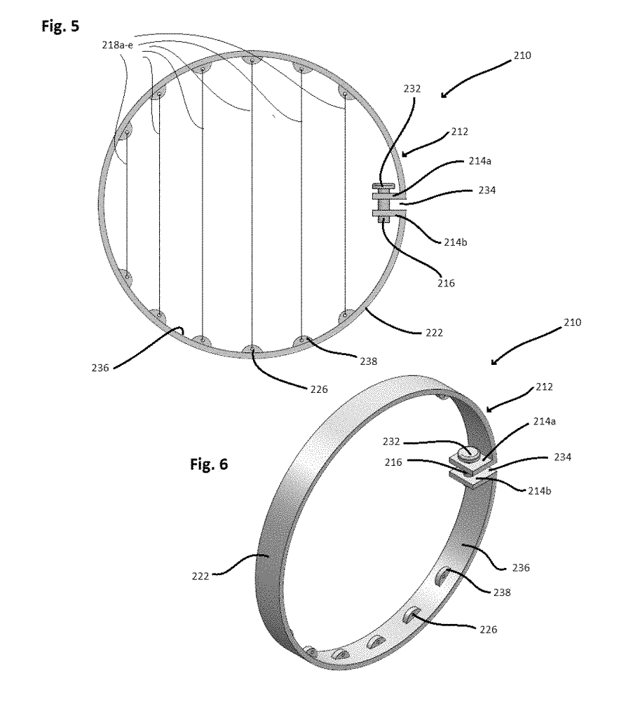

FIG. 6 illustrates a perspective view of the third embodiment of a mechanical reverb device 210 including an annular hoop formed in one section 212, with one break 234 in the continuity of the hoop to allow the hoop to open and close, two ends of the loop each having a flange 214a and 214b attached together by a set screw 216 that can be adjusted to tighten the hoop against the inner wall of a drum by rotating set screw knurled screw head 232, opening a space between the hoop 212. The hoop having one exterior wall surface 222 designed to press against the inner diameter of the drum shell, and an interior surface 236 upon which loops 238 are stamped or formed, each loop having spring attachment apertures 226 for the mounting of reverberation springs 218. Six reverberation springs 218a, 218b, 218c, 218d, 218e and 218f are installed through the spring mounting apertures to alter the sound of the drum when the drum is struck on the drum head or rim.

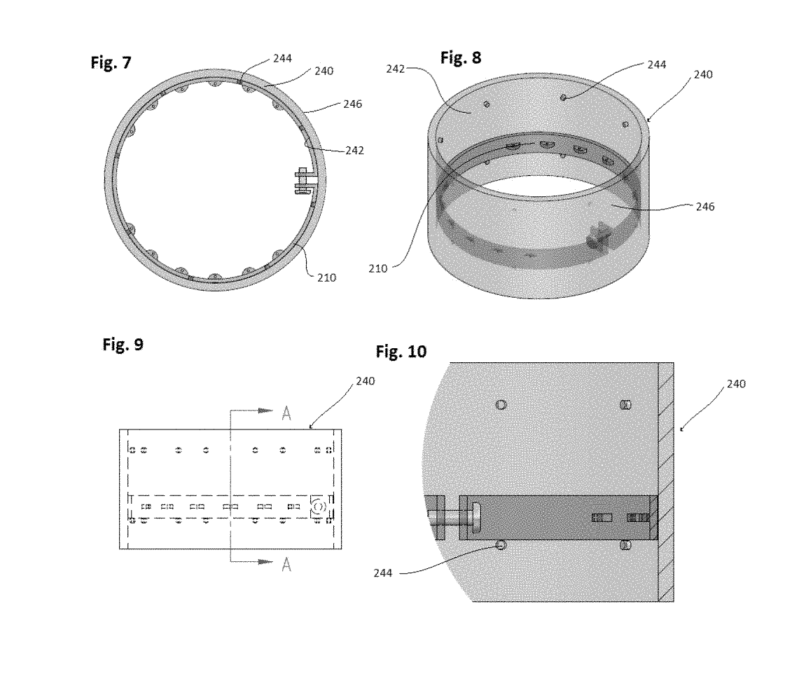

FIG. 7 illustrates a top view of the third embodiment of a mechanical reverb device 210 installed into drum shell 240, drum having a number of internal drum screws 244, an external surface 246 and an interior surface 242. As previously described, the third embodiment includes an annular hoop formed in one section 212, with one break 234 in the continuity of the hoop to allow the hoop to open and close, two ends of the loop each having a flange 214a and 214b attached together by a set screw 216 that can be adjusted to tighten the hoop against the drum interior surface 242 of a drum by rotating set screw knurled screw head 232, opening a space between the hoop 212. The hoop having one exterior wall surface 222 designed to press against the inner diameter of the drum shell 242, and an interior surface 236 upon which loops 238 are stamped or formed, each loop having spring attachment apertures 226 for the mounting of reverberation springs 218. Six reverberation springs 218a, 218b, 218c, 218d, 218e and 218f are installed through the spring mounting apertures to alter the sound of the drum when the drum is struck on the drum head or rim.

FIG. 8 illustrates a perspective view of the third embodiment of a mechanical reverb device 210 installed into drum shell 240, drum having a number of internal drum screws 244, an external surface 246 and an interior surface 242. All features as previously described above.

FIG. 9 illustrates a side view of the third embodiment of a mechanical reverb device 210 installed into drum shell 240, drum having a number of internal drum screws 244, an external surface 246 and an interior surface 242. All features as previously described above.

FIG. 10 illustrates a cross section view of the third embodiment of a mechanical reverb device 210 installed into drum shell 240, drum having a number of internal drum screws 244, an external surface 246 and an interior surface 242. All features as previously described above. It can be seen that the hoop bottom surface 248 is in contact with the internal screws of the drum, thus supporting the mechanical reverb device from moving.

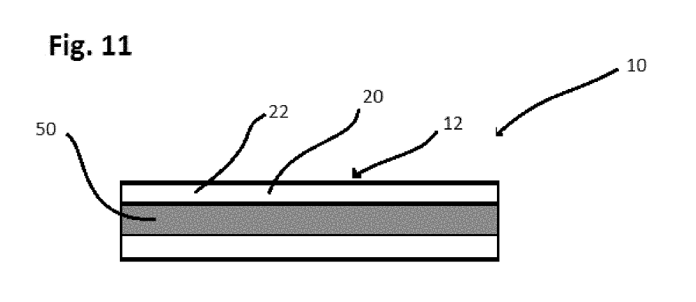

FIG. 11 illustrates a side view of a section of the first embodiment mechanical reverb device 10 as described above and including one partial annular hoop section 12. The hoop cross section is in the form of an L with the one exterior wall 20 having an exterior wall surface 22 having attached to it an alternate more flexible material 50 to flexibly interact and provide bearing surface designed to press against the inner diameter of the drum shell.

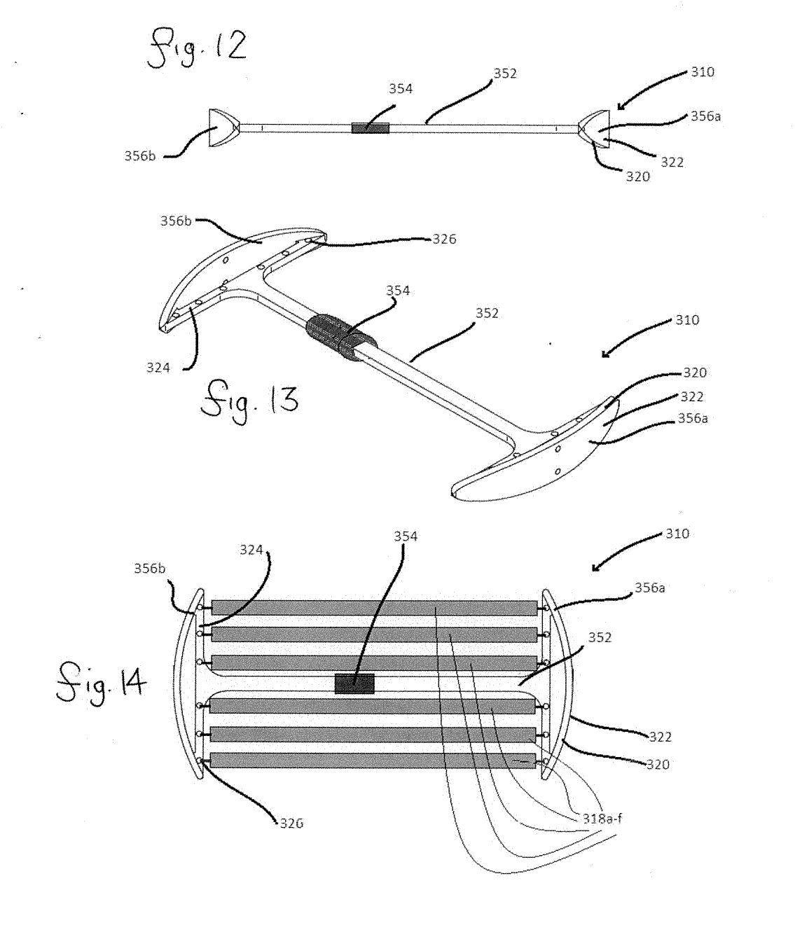

FIG. 12 illustrates a perspective view fourth embodiment of a mechanical reverb device 310 where the removable attachment means is in the form of an I-beam, with the central main beam 352 crossing the interior of the drum, central beam being split with threaded ends on each cut surface extending in alignment with the length of the beam, and each said threaded end being attached with a threaded length adjustment screw knob 354 which can be rotated to extend or shorten the length of the central beam. Partial arch members 356a and 356b at each end shaped to match the contours of the interior of the drum, each having an exterior wall 320 having an exterior wall surface 322 designed to press against the inner diameter of the drum shell when the threaded length adjustment component 354 is rotated to lengthen the central beam, and a reverberation spring mounting surface 324 extending across the arch having spring attachment apertures 326 for the mounting of reverberation springs 318.

FIG. 13 illustrates a side view of the fourth embodiment of a mechanical reverb device 310 where the removable attachment means is in the form of an I-beam, with the central main beam 352 crossing the interior of the drum, central beam being split with threaded ends on each cut surface extending perpendicular to the length of the beam, and each said threaded end being attached with a threaded length adjustment component 354 which can be rotated to extend or shorten the length of the central beam. Partial arch members 356a and 356b at each end shaped to match the contours of the interior of the drum each having an exterior wall 320 having an exterior wall surface 322 designed to press against the inner diameter of the drum shell when the threaded length adjustment component 354 is rotated to lengthen the central beam, and a reverberation spring mounting surface 324 extending across the arch having spring attachment apertures 326 for the mounting of reverberation springs 318.

FIG. 14 illustrates a top view of fourth embodiment of a mechanical reverb device 310 where the removable attachment means is in the form of an I-beam, with the central main beam 352 crossing the interior of the drum, central beam being split with threaded ends on each cut surface extending perpendicular to the length of the beam, and each said threaded end being attached with a threaded length adjustment component 354 which can be rotated to extend or shorten the length of the central beam. Partial arch members 356a and 356b at each end shaped to match the contours of the interior of the drum each having an exterior wall 320 having an exterior wall surface 322 designed to press against the inner diameter of the drum shell when the threaded length adjustment component 354 is rotated to lengthen the central beam, and a reverberation spring mounting surface 324 extending across the arch having spring attachment apertures 326 for the mounting of reverberation springs 318. Six reverberation springs 318a, 318b, 318c, 318d, 318e and 318f are installed through the spring mounting apertures to alter the sound of the drum when the drum is struck on the drum head or rim.

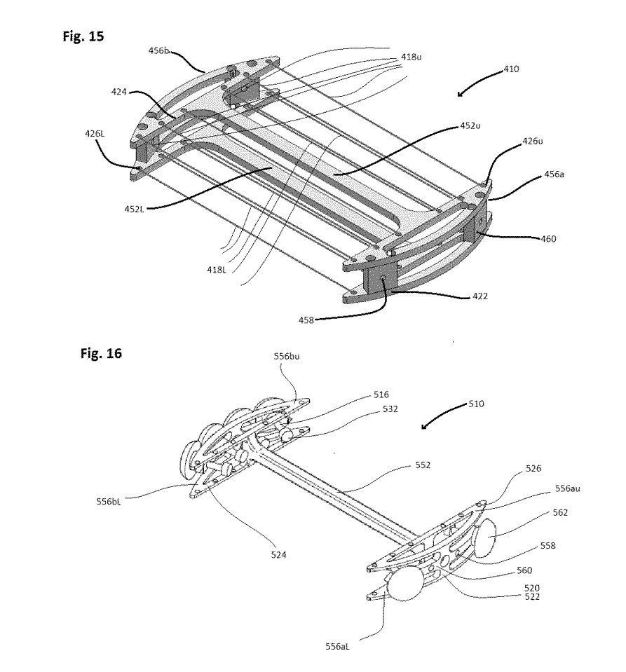

FIG. 15 illustrates a perspective view of a fifth embodiment of a mechanical reverb device 410 where the removable attachment means is in the form of two parallel I beams, with the central main beams, upper beam 452u and lower beam 452L both crossing the interior of the drum, with partial arch members 456a and 456b at each end of both the upper and lower beams shaped to be concentric with the contours of the interior of the drum, each having an exterior wall 420 having an exterior wall surface 422. Four spacers 460 connected to the upper and lower I beams and separate the upper I beam from the lower I beam by a predetermined distance, each spacer containing a threaded aperture 458 designed to receive a set screw which can be used to mount the I beam resonance device into the interior of a drum shell. All four partial arch members 456 have a reverberation spring mounting surface 424 extending across the arch having spring attachment apertures 426 for the mounting of reverberation springs 418. Six upper reverberation springs 418u are installed through the spring mounting apertures on the upper I beam and six lower reverberation springs 418L are installed through the spring mounting apertures on the lower I beam to alter the sound of the drum when the drum is struck on the drum head or rim.

FIG. 16 illustrates a perspective view of a sixth embodiment of a mechanical reverb device 510 where the removable attachment means is in the form of one I beam, with the central main beam 552 crossing the interior of the drum, with double layer partial arch members 556au and 556aL and 556bu and 556bL at each end of the beam, shaped to be concentric with the contours of the interior of the drum, each of the four arch members having an exterior wall 520 having an exterior wall surface 522. A center portion in the arch member between the upper and lower layer 560 contains threaded apertures 558 designed to receive a set screw 516 which can be used to mount the I beam resonance device into the interior of a drum shell. Set screw has a knurled knob 532 at one end and a high friction soft bearing surface 562 at the other end designed to press against the inner diameter of the drum shell when the set screw is rotated. All four partial arch members 556 have a reverberation spring mounting surface 524 extending across the arch having spring attachment apertures 526 for the mounting of reverberation springs. Six upper reverberation springs can be installed through the spring mounting apertures on the upper arch members and six lower reverberation springs can be installed through the spring mounting apertures on the lower arch member to alter the sound of the drum when the drum is struck on the drum head or rim.

It will be appreciated that the foregoing description provides examples of the disclosed system and method. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

1. A device placed inside an acoustic musical drum with the intention of creating a resonant or reverberation,
said device mounted to the interior drum
said device having one or more reverberating spring components which creates resonant or reverberating tones
Wherein the force created by the striking of the drum either on the rim or batter head causes mechanical agitation of the reverberating spring component of said device, which in turn creates a reverb or resonance effect which changes the sound of said drum.

2. The device of claim 1, where the reverberating device is irremovably attached directly to the drum shell via screws, adhesive, or other standard manufacturing means.

3. A device placed inside an acoustic musical drum with the intention of creating a resonant or reverberation,
said device mounted to the interior drum by a removable attachment means.
said device having one or more reverberating spring components which creates resonant or reverberating tones
Wherein the force created by the striking of the drum either on the rim or head causes physical agitation of the reverberating component of said device, which in turn creates a reverb or resonance effect.

4. The device of claim 3 where the removable attachment means is in the form of an annular hoop.

5. The device of claim 4 wherein the hoop is formed in two half sections, attached at one end by a hinge which is positioned to allow the hoop to open and close, and in the second end by a set screw that can be adjusted to tighten the hoop against the inner wall of a drum by opening a space between the two half sections.

6. The device of claim 4 wherein the hoop is formed in 2 or more sections, with flange sections at the ends of each hoop section, partial hoops attached at each end by a set screw attaching each flange, with each set screw adjusts the distance between each partial hoop end to tighten the hoop against the inner wall of a drum.

7. The device of claim 4 wherein the hoop is formed in one piece with one break in the continuity of the hoop, the two ends of the break in the hoop being connected by a set screw or other adjustable device, said break opening being adjustable with adjustable device so that the overall diameter of the hoop can be increased or decreased in order to tighten the hoop against the inner wall of a drum.

8. The device of claims 4-7 wherein an alternate more flexible material is attached to the outer diameter surface of the hoop to flexibly interact and provide bearing surface with the inner diameter of the drum barrel.

9. The device of claim 4-8 wherein notches are included in the exterior diameter of the hoop to allow bypass of internal screws of the inner drum barrel during installation.

10. The device of claim 4 where the removable attachment means is in the form of an I-beam, with the central main beam crossing the interior of the drum, with partial arch members at each end shaped to match the contours of the interior of the drum.

11. The device of claims 4 and 10 wherein the removable attachment means is held in place with set screws, that when rotated put pressure on the inner wall of a drum.

12. The device of claims 5-9 and 11 where the set screws are in the form of drum tension rods and can be rotated with a drum key.

13. The device of claim 10, where central beam is split with threaded ends on each cut surface extending in alignment with the length of the beam, and each said threaded end being attached with a threaded length adjustment screw knob which can be rotated to extend or shorten the length of the central beam, thus pressing the curved end of the beam into the interior sidewalls of a drum shell thereby holding it in place.

14. The device of claim 1-13 with two or more layers of reverberating components, said layers stacked in vertical direction, vertical meaning different points along the height of the drum barrel.

15. The device of claims 1-14 wherein the support frame of the reverberation device is positioned inside the drum cavity so that it rests on the drums existing internal screws.

16. The device of claims 1-15 wherein the drum contains an internal tone control muffler which is mounted inside the drum in a way that allows its position to be adjusted from the exterior of the drum. The muffler has a felt pad, which can be positioned to be in contact with or free from the reverberation device springs. When the said muffler is moved into contact with the reverberation device springs, it can exert pressure with felt pad against the springs of the reverberation device in order to reduce or eliminate the reverberation function.
